(19) United States
(12) Patent Application Publication
(10) Pub. No.: US 2024/0142802 A1
(43) Pub. Date: May 2, 2024

(54) GLASSES WITH CUSTOMIZABLE TINT-ADJUSTING EXPERIENCE

(71) Applicant: GGTR LLC, Dover, DE (US)

(72) Inventors: Chase LARSON, Denver, CO (US); Reid COVINGTON, Brooklyn, NY (US); Zhan SHI, Shanghai (CN); Liangming DU, Shenzhen (CN)

(21) Appl. No.: 18/499,812

(22) Filed: Nov. 1, 2023

Related U.S. Application Data
(60) Provisional application No. 63/381,790, filed on Nov. 1, 2022.

(51) Int. Cl. G02C 7/10

(52) U.S. Cl. CPC G02C 7/101; G08C 17/02

(57) ABSTRACT

A system with a pair of glasses, such as sunglasses, having a frame and at least one lens mounted in the frame, a light sensor mounted on the frame, and a receiver and circuitry present in the frame. The system also has app (e.g., on a cell phone) having control logic that is configured to send a command to the glasses to change the lens to a first or “dark” tint setting when a reading of the light sensor exceeds a high threshold and to send a command to change the lens to a second or “light” tint setting when a reading of the light sensor drops below a low threshold. The tint settings may change the transmittance or opacity of the lenses or the color of the lenses.

### CROSS-REFERENCE

This application claims priority to U.S. provisional application Ser. No. 63/381,790 filed Nov. 1, 2022, and titled ELECTROCHROMIC SUNGLASSES WITH CUSTOMIZABLE DIMMING EXPERIENCE, the entire disclosure of which is incorporated herein by reference for all purposes.

### BACKGROUND

Electrochromic glass, and devices made with the technology, devices such as lenses, change their light transmission properties in response to an applied voltage; this allows control over the amount of light passing through the device. A burst of electricity is required to change the transparency, but for some technologies, once the change has occurred, no electricity is needed to maintain the transparency level. That is, once the electricity is removed, the electrochromic properties remain stable. To change the transparency level, either back to the original level or to a different level, another voltage is applied.

In addition to the electrochromic design, there are other technologies that can alter the tint and/or transparency of glass and other materials.

### SUMMARY

The present disclosure describes various designs of glasses, such as sunglasses, having lenses where the optical properties are reversibly changeable by the application of voltage to the lenses. The optical properties of the lenses include any or all of tint, color, and opacity. The glasses include an ambient light sensor operably connected to the lenses that causes the tint to change based on the change in intensity of detected light and/or on the user's settings, which are inputted via an application on a remote device and/or manually on the glasses. The glasses may be referred to as “smart” glasses, automatically changing based on the user's settings and/or based on the intensity of detected light.

The glasses are highly customizable by the user. The user may be able to adjust the sensitivity to light change to change the tint from light to dark, or from dark to light, after detection of a change in light by the ambient light sensor, the rate at which the tint change occurs after detection of a change in light by the ambient light sensor, and, in some embodiments, the delay in tint change after detection of the change in light.

In one particular implementation, this disclosure describes a pair of glasses having a frame with a first side arm and a second side arm, and at least one electronically tint controlled lens in the frame, at least one light sensor on the frame, a voltage source in the frame, and control circuitry in the frame, the control circuitry including a processor and memory storing tint control logic, the tint control logic being executable by the processor to automatically adjust a tint of the at least one lens based on a light measurement from the at least one light sensor and a transition setting stored in the memory. The transition setting can be a sensitivity setting or one or more light intensity thresholds.

In another particular implementation, this disclosure describes a pair of glasses having a frame having at least one lens in the frame having adjustable tint and at least one light sensor on the frame, and control circuitry in the frame, the control circuitry including a processor and memory storing tint control logic, the tint control logic being executable by the processor to automatically adjust a tint of the at least one lens from a first tint setting to a second tint setting based on a light measurement from the light sensor and a transition setting.

In another particular implementation, this disclosure describes a system that includes a pair of glasses that have at least one electronically tint controlled lens and a light sensor in a frame, the glasses further having a voltage source and control circuitry in the frame, the control circuitry including memory storing tint control logic, the tint control logic being executable by a processor to automatically adjust a tint of the lens based on a light measurement from the light sensor and one or more thresholds stored in the memory. The system also includes a mobile application, stored in memory of a computing device, the mobile application operably connected to the glasses and executable to receive a first input indicative of a transition setting corresponding to a light level measured by the light sensor, receive a second input indicative of a first tint level of the at least one lens, receive a third input indicative of a second tint level of the at least one lens, and transmit the first input, the second input and the third input to the pair of glasses. The application is present on a computer device, such as a cell phone or tablet.

These and other aspects of the glasses and systems described herein will be apparent after consideration of the Detailed Description and figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWING

FIG. 1 is a perspective side view of a first example pair of glasses.

FIG. 2 is a front plan view of the glasses of FIG. 1.

FIG. 3 is a side plan view of the glasses of FIG. 1.

FIG. 4 is a perspective view of a remote computer device showing an application thereon.

FIG. 5 is a schematic diagram of a system having a pair of glasses and a remote computer device.

FIG. 6 is a front plan view of a second example pair of glasses.

FIG. 7 is a front plan view of a third example pair of glasses.

FIG. 8 is a front plan view of a fourth example pair of glasses.

### DETAILED DESCRIPTION

As indicated above, the present disclosure is directed to “smart” glasses, having an ambient light sensor, e.g., on the frame, that can be used to adjust the tint of the lens or lenses automatically according to the surrounding light intensity. The user (e.g., wearer) can override the automatic change (the change based on the light intensity measurement from the light sensor) and customize the lenses, such as the degree of tint, time of tint change, and rate of tint change. As used herein, “tint” is intended to encompass color and also transparency or transmittance.

The user (e.g., wearer) can customize the lenses, e.g., the tint and the change in tint, via a computer program or application on a remote device (e.g., a mobile application on a device such as a cell phone or a tablet, also referred to as an “app”) and, additionally or alternately, the user can also customize any or all of the changeable features on the glasses themselves, e.g., on the frame. For example, the user can select how dark they would like the tint on the lenses to go, how light they would like the tint on the lenses to go, how quickly the lenses transition from dark to light and vice versa (the rate of change and also any time delay for the transition), and/or how sensitive the lenses are to a change in light before they change. On occasion, the user may want to override the predetermined settings, and can do so on the app or on the glasses themselves.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

It is noted that the terms “pair of glasses” and “glasses” are used interchangeably throughout, and no distinction is intended by use of one term versus the other. Additionally, although the language a “pair of glasses” is used, one set of glasses is intended, as it is common to refer to one item of glasses as a “pair” (similar to a “pair” of pants).

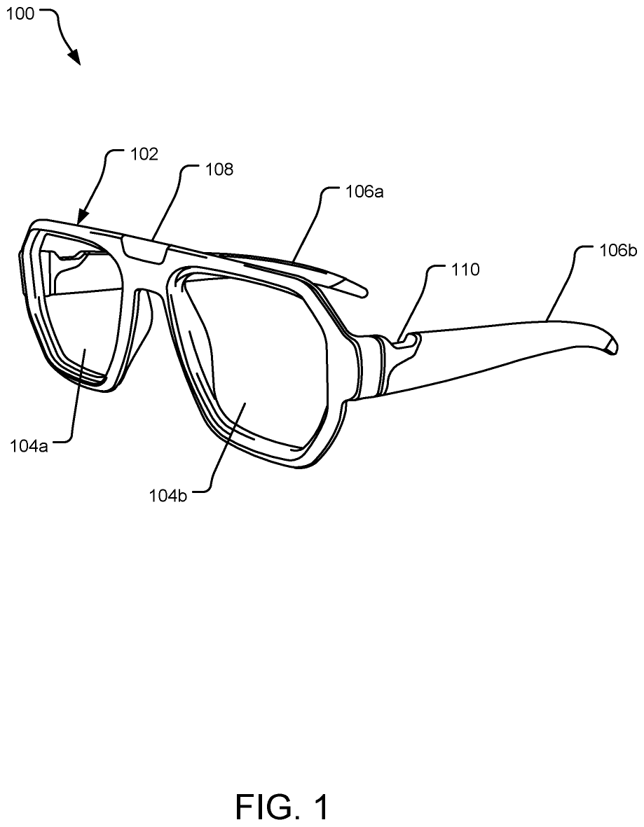

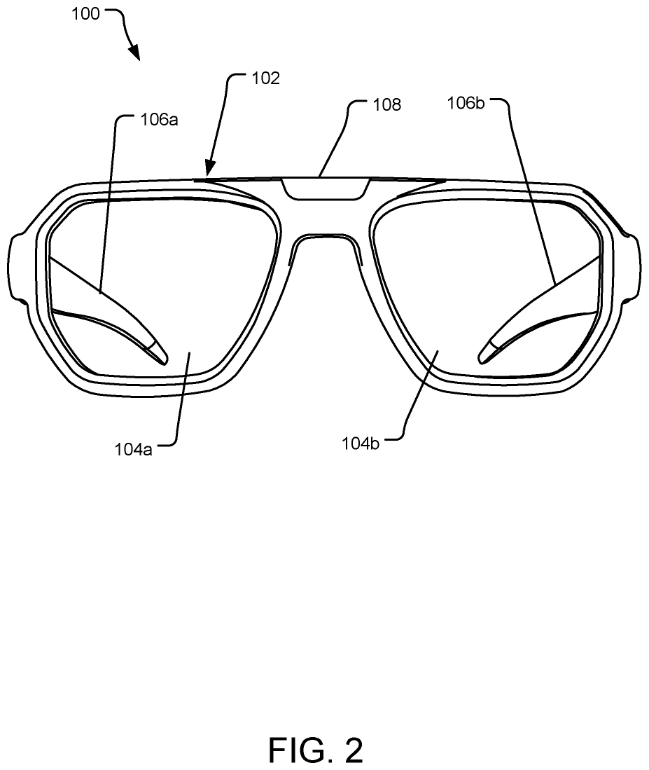

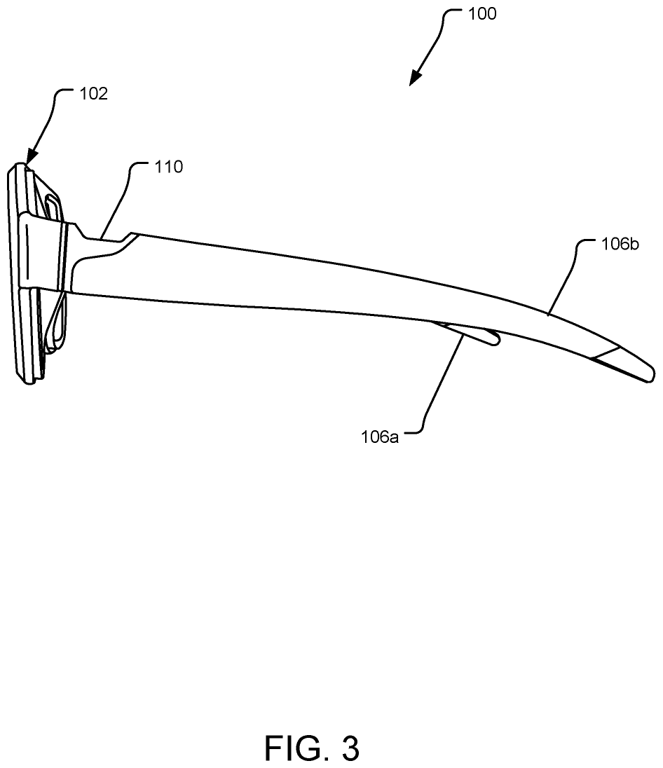

Turning to the figures, FIGS. 1 through 3 show a first embodiment of a pair of glasses according to this disclosure, particularly a pair of sunglasses 100. The sunglasses 100 have a frame 102 holding a first lens 104a and a second lens 104b, the position of the lenses 104 configured to be essentially aligned with the wearer's eyes for the wearer to see through the lenses 104. The frame 102 includes a first side arm 106a hinged to the frame 102 and a second hinged side arm 106b. At least one ambient light sensor 108 is present in the frame 102, in this design, above the bridge of the wearer's nose between the lenses 104, when the sunglasses 100 are being properly worn by a user. In other designs, the light sensor may be located elsewhere. The light sensor 108 may be partially embedded into the frame 102 or may be surface mounted.

The frame 102 may be made from any suitable material, including plastic (polymers such as, e.g., polycarbonate, polyethylene, polystyrene, and various mixtures), reinformed plastic, metal (e.g., stainless steel), composites, and the like. The frame 102 may be solid or hollow, and may have any number of layers or coatings of material. The frame 102 may be rigid or may be somewhat flexible, e.g., allowing rotational bending. The frame 102 may be any color with any decorations.

The lenses 104 are electrochromic lenses, where the optical properties are reversibly changeable by the application of voltage to the lenses 104. In other embodiments, the lenses 104 may be other lenses that have an adjustable tint or transparency, such as liquid crystal display (LCD) lenses or another electronically tint controlled lens or lenses. The lenses 104 may or may not be actual glass.

The lenses 104 are configured to change their tint and, in this embodiment, the optical transmission (e.g., light transmittance) through the lenses 104 so that the wearer observes different levels of transmission, visible as different levels of tint on the lenses 104. In use, a first voltage is applied to the lenses 104 to obtain a first tint level and a second (different) voltage is applied to the lenses 104 to obtain a second (different) tint level. The voltage may be high voltage or low voltage. In some designs, the voltage is maintained to maintain the tint level, and in other designs, the tint level remains even when the voltage is removed.

Appropriate electronics, including circuitry and a voltage source such as a battery, to operate the lenses 104 can be located anywhere in or on the glasses 100, although the frame 102 is particularly suited for retaining the electronics therein. The battery may be a single use battery or a rechargeable battery. Examples of suitable batteries include NiCad, lithium, lithium-ion, zinc-carbon, and alkaline batteries. In addition to the battery, an energy harvesting mechanism may be included with the electronics. Vibration-to-electricity transduction can be accomplished via electrostatic, electromagnetic, or piezoelectric methods. Examples of suitable electro-mechanical energy-harvesting techniques or devices include ceramic lead zirconate titanate (PZT), thin film PZT MEMS devices, and aluminum nitride (AlN) MEMS devices.

The sensor 108 is a sensor configured to measure the amount of light reaching the lenses 104; for this reason, a desired, yet not required, location for the sensor 108 is on the front of the frame 102, proximate the lenses 104. There are numerous commercially available light sensors that could be used as the sensor 108.

The sensor 108 provides a measurement of the light intensity to which the sunglasses 100, and thus the wearer's eyes, are exposed. Based on changes in the measured ambient light intensity, the lenses 104 switch their tint. For example, the lenses 104 switch to a “dark” tint setting when a change in the measured light increases a predetermined amount (typically, over a set period of time), and switch to a “light” tint setting when a change in the measured light decreases a predetermined amount. In another embodiment, the lenses 104 switch to a “dark” tint setting when a reading of the ambient light sensor 108 exceeds a “high” threshold and switch to a “light” tint setting when a reading of the ambient light sensor 108 drops below a “low” threshold. In some embodiments, the tint settings may change the color of the lenses in addition to or instead of changing the light transmittance through the lenses 104.

In some embodiments, two different thresholds are present, one for switching to the “dark” tint setting and one for switching to the “light” tint setting. However, the same threshold may be used for both; if the light intensity is above the threshold, then the lenses 104 switch to the “dark” tint setting, and when the light intension is below that same threshold, the lenses 104 switch to the “light” tint setting.

These thresholds and other adjustments can be the default settings set by the manufacturer, or set either manually on the glasses 100 themselves or on a wirelessly connected computer system, such as an application, or “app,” on a cell phone or tablet. The user can customize their “dimming experience” by controlling the settings that dictate how sensitive the lenses are to light change (e.g., what change in level of light triggers the change) or controlling the threshold settings that dictate when the lenses will change (e.g., at what level of ambient light will the lenses change). These settings that control when the lenses change, whether a sensitivity level or at least one threshold, are referred to herein as “transition setting” or the like. The user can adjust the transition setting to customize their glasses.

The user can adjust the sensitivity to light change setting, which dictates the amount of change in the ambient light to warrant a lens tint change. For example, if the wearer is particularly sensitive to light, the wearer can set the sunglasses 100 to be more sensitive to ambient light change; that is, e.g., a little increase in light causes the lenses 104 to adjust to the darker settings. Additionally or alternately, the user can set one or more predefined thresholds at which the tint of the lenses change. For example, the user can set a “high” threshold so that, when the high threshold is reached by bright ambient light, it causes the lenses to switch to the “dark” tint setting. When a set “low” threshold is reached, when it is dark or at low ambient light, the lenses reverse the dimming effect to the “light” tint setting.

In addition to the user customizing when the lenses 104 change tint, the user can also customize the resulting tint level of the lenses 104, at either or both the high tint level (the “dark” tint setting) and the low tint level (the “light” tint setting).

The tint percentage of the lenses 104 will generally be configured so that 100% tint is completely opaque and 0% tint is completely transparent. These levels inversely correlate to “visual light transmittance” (“VLT”), where a VLT of 100% is perfectly transparent and a VLT of 0% is solid black, where no light can pass through. It is noted that a tint percentage (other than 0% and 100%) may or may not quantitatively inversely correlate to VLT percentage.

The selected tint levels (the “dark” tint setting, the “light” tint setting, and any others) can be based on default settings and are changed based on the user's preferences as well as the capabilities of the lenses 104.

In some embodiments, it may be desired to have one or more intermediate tint or VLT levels. For example, the sunglasses 100 may have three tint levels, a “dark” tint setting for very bright and sunny days, an “intermediate” tint setting for slightly overcast days, and a “light” tint setting for cloudy days; other examples may have four levels or more. Each and any of these tint settings can be adjustable.

In addition to the user adjusting the transition setting (e.g., sensitivity and/or light intensity thresholds) for the lens changes and the lens tint/transmittance, the wearer can control the rate of change of the lenses 104, either or both the rate of tint change and also any delay in the tint change (after the threshold is met).

Any of these settings changes can be made via the app or on the glasses 100. For example, on the glasses 100, any of all of the tint settings and transition setting can be toggled via a switch 110 on the frame 102, e.g., up on one side arm 106 and down on the other side arm 106; such a switch may be a capacitance sensor, an air-force sensor, or a tactile button. Similarly, the rate of tint change and delay in change can be adjusted via a switch or a sliding element.

Although the sunglasses 100 will typically be used by a single wearer, with the settings configured by and/or for that single wearer, in some designs the sunglasses 100 may be configured with multiple saved settings, for multiple wearers.

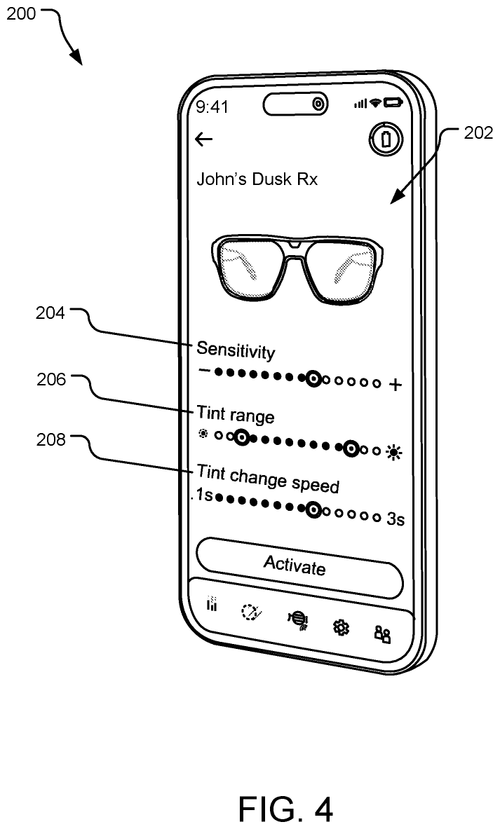

FIG. 4 provides an example of a computer device, particularly a cell phone 200, having a user interface of an example app 202 shown thereon for adjusting configuration settings for the sunglasses 100. The app 202 includes an adjustment 204 for “sensitivity,” an adjustment 206 for “tint range,” and an adjustment 208 for “tint change speed” (also referred to as tint rate change or the like). Each of these adjustments 204, 206, 208, has an incremental slide indicator.

The sensitivity adjustment 204 allows the user to set how much of a light change is measured by the light sensor before changing the tint from one level to another level, e.g., from the “dark” tint level to the “light” tint level, and vice versa.

The tint range adjustment 206 allows the user to set the tint level of the lens; that is, it allows the user to choose the “light” tint setting and the “dark” tint setting of the lenses.

For example, a user may decide they want the highest tint level to allow, e.g., 25 VLT %, 20 VLT %, 10 VLT %, or any other percentage of transmittance, e.g. on very bright and sunny days, and may want the lowest tint level to allow, e.g., 50 VLT %, 60 VLT %, 70% VLT, which may be desired on cloudy days. As specific examples, a tint level for a “light” tint setting can be 60 VLT % and a corresponding “dark” setting can be 20 VLT %, in another example, a tint level for a “light” setting can be 30 VLT % and a corresponding “dark” setting can be 5 VLT %.

The number of available tint levels may be infinite or may be limited; for example, the tint levels available to be chosen may be preset. For example, the available tint levels may be those which provide, e.g., increments of 5 VLT % between 25 VLT % and 60 VLT %. The number of available tint levels is at least three, and in some embodiments at least four, in other embodiments, 8 to 12 preset levels.

The change, between the “light” tint setting and the “dark” tint setting, occurs based on light sensor of the glasses reporting a light change that meets the value of the sensitivity adjustment 204.

Other embodiments of an app may include an adjustment to set one or more thresholds, the thresholds representing a light level at which the lenses change their tint. For example, the lenses switch to a “dark” tint setting when a reading of the ambient light sensor exceeds a “high” threshold and the lenses switch to a “light” tint setting when a reading of the ambient light sensor 108 drops below a “low” threshold. In another embodiment, having only one threshold, if the light intensity is above the threshold, then the lenses switch to the “dark” tint setting, and if the light intensity is below that same threshold, the lenses switch to the “light” tint setting.

The tint change speed adjustment 208 allows the user to set how quickly the tint changes from the “light” tint setting to the “dark” tint setting (rate of change), and vice versa. In this particular example, the tint change timing can be selected from 0.1 second to 3 seconds.

Additionally, this app user interface includes an image of the paired glasses as well as an icon indicating the battery level of the glasses. Some apps may be configured to support multiple glasses; thus, identification of the linked glasses in the user interface is beneficial.

The app 202 can be used to set the desired levels, either on a permanent or a temporary basis. For example, settings via the app 202 may be remembered permanently (until changed again in the app 202), or the settings may revert to an initial setting, e.g., every day. The app 202 can be used to change (override) settings that had been input physically on the glasses, or the physical input can change (override) the app settings.

It is noted that in this example app 202, only the tint change speed adjustment 208 utilizes a quantifiable number range; both the sensitivity adjustment 204 and the tint range adjustment 206 are qualifiable ranges. This may be, for example, due to the constraints of the lenses themselves, which would not want to be overtly disclosed to the user; for example, some lens technology may not allow the full transmission spectrum between 0 VLT % and 100 VLT %. Thus, by providing a qualitative scale, the user is unaware of system limitations. For some features, such as sensitivity, the feature is more difficult to quantify in a manner that is easy for a user to readily understand.

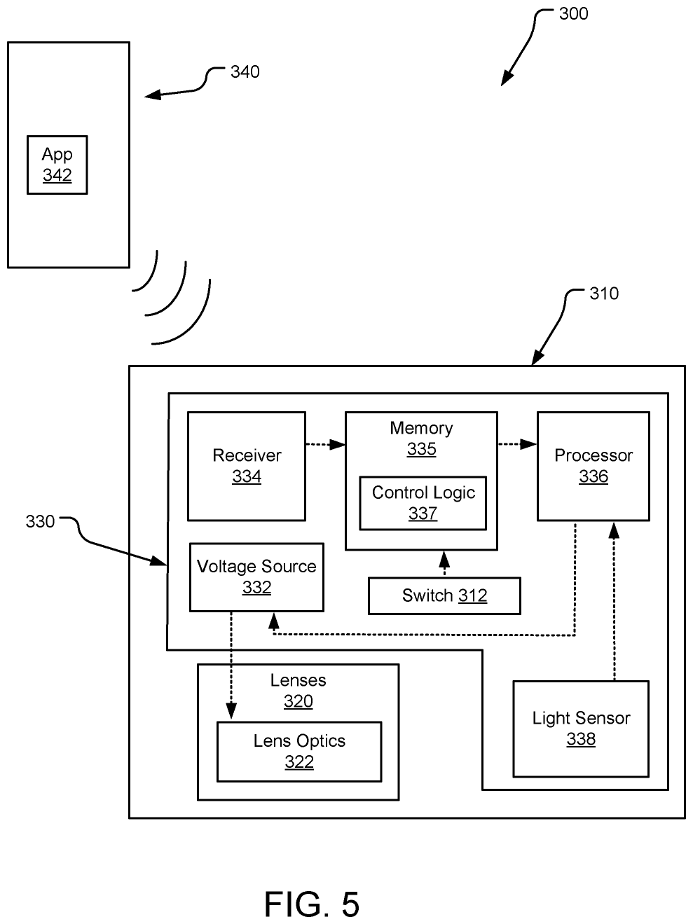

Referring to FIG. 5, a simplified block diagram shows the general arrangement of a system 300 that includes glasses of this disclosure. The system 300 includes a pair of glasses 310 and a remote computer device such as a cell phone 340 having an app 342 into which the user can input desired settings for the glasses 310. For example, the app 342 may have a slide or scroller to select the desired tint level of the lens in the glasses 310 or the rate of change of the tint, or a button can be used to select preset levels.

The glasses 310 have at least one electrically-tint controlled lens 320 held in a frame 330. The lens 320 includes optics 322 that control the tint of the lens 320 and a voltage source 332 such as a battery (e.g., 6V, 12V) or a micro-electro-mechanical harvesting device (a MEMS device) present in the frame 330 to provide a voltage to operate the optics 322. A light sensor 338 is also present in the frame 330.

Within the frame 330 of the glasses 310 is a receiver 334 for receiving a signal (e.g., tint control commands) from the cell phone 340 via the app 342; the signal may be transmitted, e.g., via RF communication such as ZigBee, Bluetooth Low Energy (BLE), WiFi (sometimes referred to as WLAN), and WiMax, or a CDMA/GMS/LTE communication network, which can be considered to be a cellular frequency. Commands received at the receiver 334 are executed according to the control logic 337, which is stored in memory 335 and locally executed by a processor 336. In various implementations, aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The processor 336 is configured to execute the control logic 337 to process the incoming commands, such as instructions to update stored tint levels, and to generate control signals to change the voltage at the voltage source 332 and thereby controllably vary the tint of the lens 320 based on the control logic 337, the measurements of the light sensor 338, and the stored tint settings. Collectively, the processor 336, memory 335, and the control logic 337 are referenced to herein as “control circuitry” below.

The user, via the app 342, has the option to preselect the tint levels of the lens 320 corresponding to “dark” and “light” tint settings, and also has the option to either set how sensitive to light the glasses 310 are, or to set one or more thresholds for the ambient light sensor 338. The user may also be able to configure one or more settings to control the rate of change from “dark” to “light” settings and vice versa, that is, how fast or slow the tint progression from “dark” to “light” settings and vice versa is to occur (e.g., less than 1 second, over 1 second, 3 seconds, 5 seconds). In still another implementation, the user can configure a setting regarding the onset of the change, or, the delay in the change, from “dark” to “light” tint settings and vice versa, that is, how soon should the lenses change after a change in ambient light is detected (e.g., within 0.5 second, 1 second).

The control circuitry sends instructions to the lens 320 implementing those settings, upon indication from the light sensor 338 that the ambient light has sufficiently changed (e.g., increased or decreased) to warrant a change in the lens tint based on the transition setting. The control logic 337 sends a control signal to alter a voltage signal applied to alter a tint of the lens 320, at the set time delay and/or at the set rate, as instructed.

In one implementation, the control circuitry generates a first control signal to change the tint of the lens 320 to a “dark” tint setting in response to detecting an increase in ambient light, at the ambient light sensor 338, that exceeds a sensitivity setting. The control circuitry generates a second control signal to change the tint of the lens 320 to a “light” tint setting in response to detecting, at the ambient light sensor 338, a decreased in the ambient light that exceeds the sensitivity setting.

In another implementation, the control circuitry generates a first control signal to change the tint of the lens 320 to a “dark” tint setting in response to detecting ambient light, at the ambient light sensor 338, that exceeds a high threshold. The control circuitry generates a second control signal to change the tint of the lens 320 to a “light” tint setting in response to detecting, at the ambient light sensor 338, ambient light that has dropped below a low threshold.

As indicated above with respect to the sunglasses 100, the glasses 310 may have a physical switch 312 or two on the frame 330 to change any of the tint settings and/or thresholds. Any change via the switch 312 on the frame 330 may be a temporary (override) change or may be a permanent change, until again changed via the switch 312 or by the app 342. These manually entered settings may be saved to the control logic 337 in the memory 335 or to a different memory.

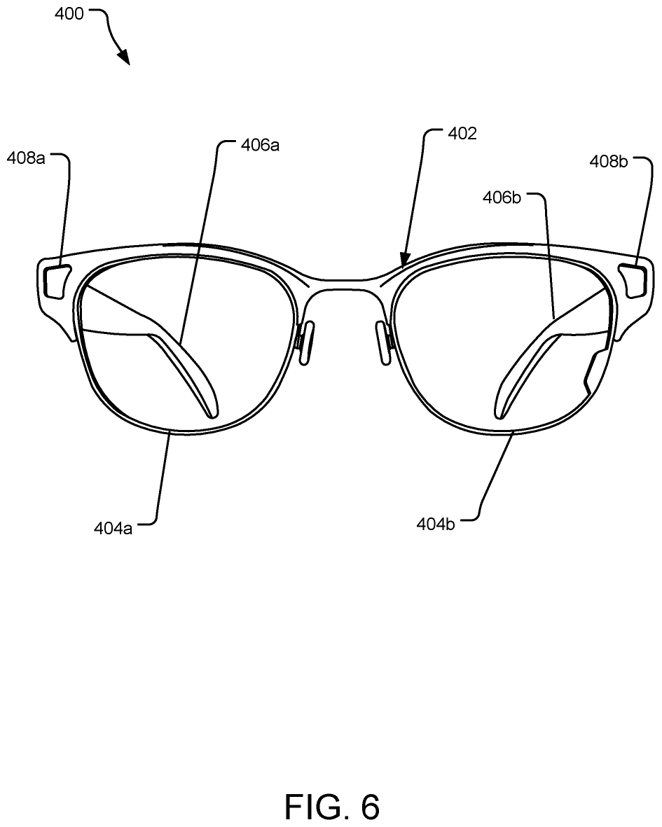

FIG. 6 shows another example of customizable glasses, particularly sunglasses 400, having the same or similar tint-changing features as described above for the sunglasses 100 of FIGS. 1 through 3. The sunglasses 400 have a frame 402, a first lens 404a and a second lens 404b both held in the frame, and a first hinged side arm 406a and a second hinged side arm 406b. Unlike the sunglasses 100, however, the frame 402 of the sunglasses 400 is a partial frame that does not surround the entire lens 404; that is, the frame 402 is not present on or at the bottom of the lenses 404. Additionally, the frame 402 above the bridge of the wearer's nose is significantly smaller than in the sunglasses 100.

In this design, a first light sensor 408a is present in the frame 402 proximate the first side arm 406a, proximate the user's temples, and a second light sensor 408b is present in the frame 402 proximate the second side arm 406b. In an alternate design, a light sensor 408 is present at only one of the sides.

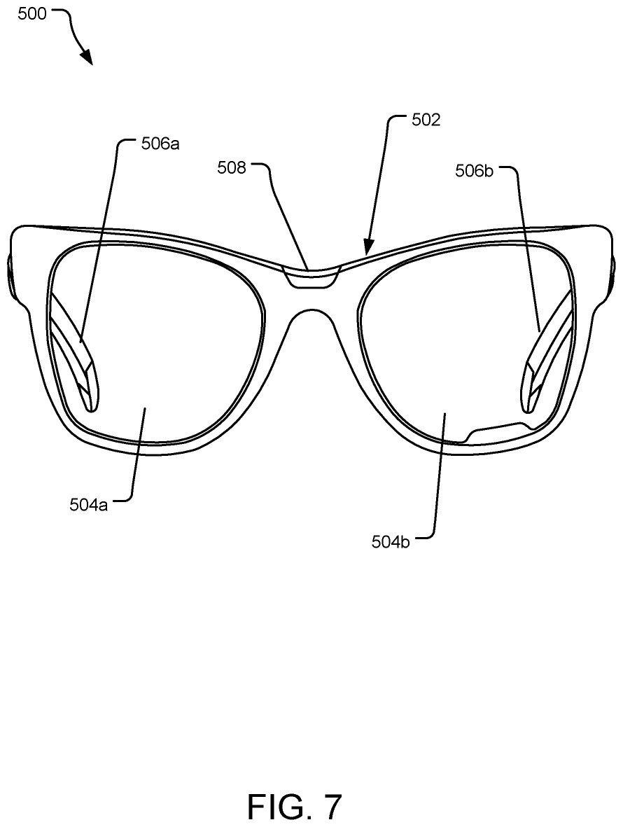

FIG. 7 shows another example of customizable glasses, particularly sunglasses 500, having the same or similar tint-changing features as described above for sunglasses 100 of FIGS. 1 through 3. The sunglasses 500 have a frame 502, a first lens 504a and a second lens 504b both held in the frame 502, and a first side arm 506a and a second side arm 506b. A light sensor 508 is present in the frame 502, in this design above the bridge of the wearer's nose between the lenses 504. As with the sunglasses 100, the frame 502 of the sunglasses 500 extends around the entire periphery of the lens 504. The shape of the lenses 504 and the frame 502 produce a “cat eye” look to the sunglasses 500.

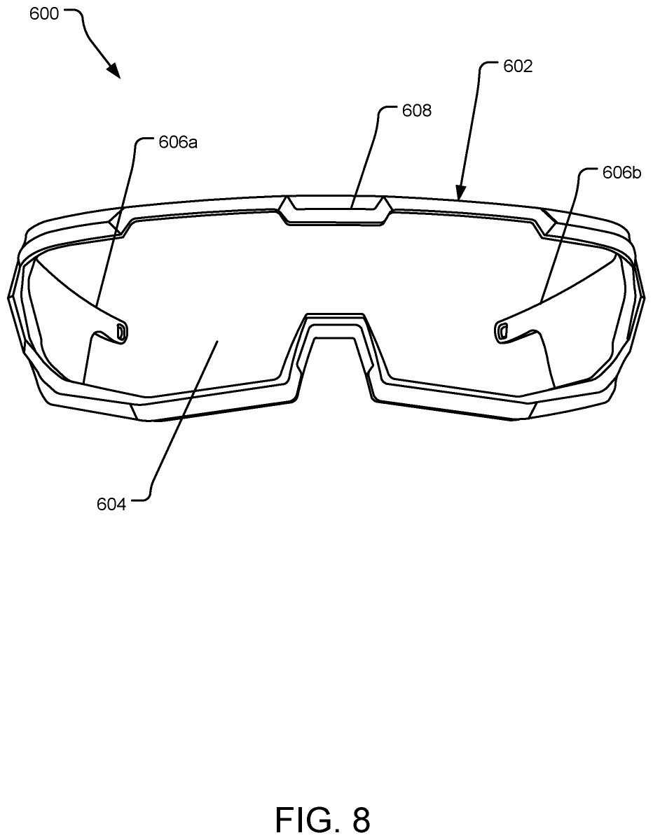

FIG. 8 shows another example of customizable glasses, particularly sunglasses 600, having the same or similar tint-changing features as described above for sunglasses 100 of FIGS. 1 through 3. The sunglasses 600 have a frame 602, a single lens 604 held in the frame 602, and a first side arm 606a and a second side arm 606b. A light sensor 608 is present in the frame 602, in this design above the bridge of the wearer's nose. As with the sunglasses 100, the frame 602 of the sunglasses 600 extends around the entire periphery of the lens 604, but there is only one lens 604 present, extending across both of the user's eyes. Additionally, the side arms 606 have a greater thickness; the side arms 606 may or may not be hinged to the front portion of the frame 602. The overall wrap-around configuration of the sunglasses 600 is often synonymous with athletic eyewear.

In addition to having over-the-counter, stock lenses in the glasses, the lenses may be customized for the particular wearer, e.g., as “prescription” lenses. These prescription lenses may be configured for near sightedness, far sightedness, or both (e.g., bifocals, or trifocals). The prescription lenses do not affect the configurable features of the glasses.

Additionally, whether a prescription lens or not, the lenses 104, 404, 504, 604 and others may be any color(s), polarized, have a reflective or anti-glare coating, and/or have a UV/IR blocking coating. The lenses may be “mirrored” lenses.

Still further, the at least one ambient sensor may be positioned on any location of the frame, such as above the nose (as in sunglasses 100, 500, 600) at any location (e.g., at the top of the frame above the nose or in the center of the frame above the nose) or in a different location of the frame (as in the sunglasses 400). In some designs, sensors may be present in multiple locations, such as at the sides (temples) and in the center above the nose bridge.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

What is claimed is:

1. A pair of glasses comprising:
a frame having a first side arm and a second side arm, and at least one electronically tint controlled lens in the frame;
at least one light sensor on the frame;
a voltage source in the frame; and
control circuitry in the frame, the control circuitry including a processor and memory storing tint control logic, the tint control logic being executable by the processor to automatically adjust a tint of the at least one electronically tint controlled lens based on a light measurement from the light sensor and a transition setting stored in the memory.

2. The glasses of claim 1, wherein the transition setting is a sensitivity setting stored in the memory.

3. The glasses of claim 1, wherein the transition setting is at least one threshold stored in the memory.

4. The glasses of claim 1, wherein the memory stores a setting for at least one or more of a tint rate change, a tint change time delay, a dark tint setting, a light tint setting, and a sensitivity setting.

5. The glasses of claim 4, wherein the tint control logic automatically adjusts the tint of the at least one electronically tint controlled lens between the dark tint setting and the light tint setting.

6. The glasses of claim 1 comprising two electronically tint controlled lenses in the frame.

7. The glasses of claim 1 further comprising a receiver in the frame.

8. The glasses of claim 1 further comprising a manual switch on the frame.

9. A pair of glasses comprising:
a frame having at least one lens in the frame having adjustable tint and at least one light sensor on the frame; and
control circuitry in the frame, the control circuitry including a processor and memory storing tint control logic, the tint control logic being executable by the processor to automatically adjust a tint of the at least one lens from a first tint setting to a second tint setting based on a light measurement from the light sensor and a transition setting.

10. The glasses of claim 9 comprising two adjustable tint lenses in the frame.

11. The glasses of claim 9, wherein the at least one lens having adjustable tint is an electrochromic lens, and the glasses further comprising a voltage source in the frame.

12. The glasses of claim 9, wherein the tint control logic automatically adjusts the tint of the at least one lens from the second tint setting to the first tint setting based on the light measurement from the light sensor and a second light intensity threshold.

13. The glasses of claim 9, wherein the tint control logic includes a setting for at least one or more of a tint rate change, a tint change delay, the first tint setting, the second tint setting, and a sensitivity setting.

14. The glasses of claim 13, wherein the first tint setting is a lightest tint setting and the second tint setting is a darkest tint setting.

15. The glasses of claim 9, wherein the at least one lens is a prescription lens.

16. The glasses of claim 9 further comprising a manual switch on the frame.

17. A system comprising:
a pair of glasses comprising at least one electronically tint controlled lens and a light sensor in a frame, the glasses further comprising a voltage source and control circuitry in the frame, the control circuitry including a processor and memory storing tint control logic, the tint control logic being executable by the processor to automatically adjust a tint of the at least one electronically tint controlled lens based on a light measurement from the light sensor and a sensitivity setting or at least one thresholds stored in the memory; and
a mobile application, stored in memory of a computing device, the mobile application operably connected to the glasses and executable to:
receive a first input indicative of a transition setting corresponding to a light level measured by the light sensor;
receive a second input indicative of a first tint level of the at least one electronically tint controlled lens;
receive a third input indicative of a second tint level of the at least one electronically tint controlled lens; and
transmit the first input, the second input and the third input to the pair of glasses.

18. The system of claim 17, wherein the mobile application is further executable to:
receive a fourth input to control a tint transition time delay between the first tint level and the second tint level.

19. The system of claim 17, wherein the mobile application is further executable to:
receive a fifth input to control a tint transition rate between the first tint level and the second tint level.

20. The system of claim 17, wherein the computing device is a mobile phone.
